(19) United States
(12) Patent Application Publication
(10) Pub. No.: US 2026/0154254 A1
(43) Pub. Date: Jun. 4, 2026

(54) DISTRIBUTED DATABASE WITH INDEPENDENT SCALING OF COMMIT LAYER AND STORAGE LAYER

(71) Applicant: Amazon Technologies, Inc., Seattle, WA (US)

(72) Inventors: Marc Brooker, Seattle, WA (US); Steven Michael Hershey, Seattle, WA (US); Marc Bowes, Seattle, WA (US); Izak Van Der Merwe, Seattle, WA (US); Gourav Roy, Issaquah, WA (US)

(73) Assignee: Amazon Technologies, Inc., Seattle, WA (US)

(21) Appl. No.: 18/964,233

(22) Filed: Nov. 29, 2024

(51) Int. Cl. G06F 16/23; G06F 16/27

(52) U.S. Cl. CPC G06F 16/2379; G06F 16/27

(57) ABSTRACT

A database system includes a commit layer implemented using a first set of host computing devices and a storage layer implemented using a second set of host computing devices. A control plane of the distributed database system determines a first sharding scheme for the commit layer and a second sharding scheme for the storage layer, wherein the first and second sharding schemes are not required to be the same. Also, in some embodiments, the second sharding scheme used for the storage layer enables overlapping key spaces across the shards of the storage layer, wherein various ones of the shards are optimized for different types of workloads.

### BACKGROUND

Database systems may be scaled by increasing a number of partitions used to store data in the database. Partition scaling often increases capacity to read data from the database and to write data to the database. Such database systems typically use the same host computing devices to perform both reads and writes. Thus, capacity to perform writes scales with capacity to perform reads and vice versa. However, customer workloads may include different levels of load for reads versus writes for particular key ranges of a database. Thus, having read capacity coupled to write capacity can lead to inefficient allocations of resources, wherein some partitions are over-scaled to perform writes, or under scaled to perform reads.

### BRIEF DESCRIPTION OF THE DRAWINGS

FIG. 1 is a block diagram illustrating a database service which includes a commit layer that manages commitment of writes using a first key sharding scheme and a corresponding first set of shards and a storage layer that stores data using a second key sharding scheme and a corresponding second set of shards, according to some embodiments.

FIG. 2A is a block diagram illustrating a control plane monitoring the first set of shards of the commit layer and the second set of shards of the storage layer for shard heat, according to some embodiments.

FIG. 2B is a block diagram illustrating a re-sharding of the commit layer shards and a re-sharding of the storage layer shards, wherein different re-sharding schemes are used to re-shard the commit layer and the storage layer, respectively, according to some embodiments.

FIG. 3 is a block diagram illustrating example sharding schemes that may be used by the commit layer and the storage layer, wherein the sharding scheme used by the commit layer does not allow for overlap of keys between shards, and wherein the sharding scheme used by the storage layer allows for at least some keys to be included in multiple shards, according to some embodiments.

FIG. 4 is a block diagram illustrating example sharding schemes that may be used by the commit layer and the storage layer, wherein the storage layer includes one or more workload customized shards that include keys also included in one or more other shards of the storage layer, according to some embodiments.

FIG. 5 is a block diagram illustrating components of the commit layer, according to some embodiments.

FIG. 6 is a block diagram illustrating example key mapping functions that may be used by an adjudicator instance of a commit layer in order to assign keys to particular shards managed by the commit layer, according to some embodiments.

FIG. 7 is a block diagram illustrating components of the storage layer, according to some embodiments.

FIG. 8 is a flowchart for a process for monitoring write and read heat load and re-sharding the commit layer and/or the storage layer of a distributed database based on the monitored write loads and heat loads, according to some embodiments.

FIG. 9 is a flowchart for a process for determining a shard (e.g. adjudicator) to which a key is to be assigned based on discovered locality, according to some embodiments.

FIG. 10 is a block diagram illustrating various components of a database service and storage service that host a distributed database, according to some embodiments.

FIG. 11 is a block diagram illustrating a provider network that may implement database services that implement techniques described herein, according to some embodiments.

FIG. 12 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A database system may include query processors, which clients may connect to in order to execute reads and writes on a database. The database system further includes a commit layer, wherein the query processors send writes to the commit layer to be durably committed in the distributed database, and wherein the commit layer provides an acknowledgment back to the query processors upon successful commitment of a write into the distributed database. Also, the database system includes a storage layer, wherein management instances of the storage layer read committed writes from a journal of the commit layer and store the committed writes at shards stored by storage nodes of the storage layer. The commit layer further includes adjudicator instances that adjudicate that cause a given write (received from a query processor) to be written to the journal of the commit layer and adjudicate that the write has been committed prior to providing a write acknowledgement back to the query processors.

In some embodiments, a first sharding scheme is used to shard one or more tables for which writes are managed by the commit layer (e.g., adjudicators) and a second sharding scheme is used to organize data stored by the storage nodes for the one or more tables. Thus, the commit layer and the storage layer are independently sharded and are not required to follow a common sharding scheme.

For example, keys or key ranges that receive a larger volume of writes may differ from keys or key ranges which receive a larger volume of reads. Accordingly, the storage layer (which is used to service reads) may include a different number and/or arrangement of shards than the commit layer (which is used to commit writes). Additionally, replicas of shards may be used in the storage layer to increase capacity to respond to reads, wherein the commit layer is not required to mirror the storage layer and therefore the commit layer does not include the replicas added to the storage layer. As a more particular example, consider a table with a first number of rows and a second number of columns, wherein data items belong to an intersection of a row and column. Writes may primarily occur at a latest row, whereas reads may be directed to earlier rows and may only affect certain columns of the earlier rows. Thus, for the commit layer an efficient sharding scheme may group the most recent rows and all columns of the most recent rows into a first shard and may include a larger number of rows and columns for already written rows in another shard. Conversely, the storage layer may group together rows and/or columns that are more frequently read into a same shard and may include less frequently read rows and/or columns in another shard. As described herein, decoupling the commit layer from the storage layer allows for different sharding schemes to be used for each, which enables customization to address the varying load patterns between reads and writes, such as described in the above example.

In some embodiments, an adjudicator instance of the commit layer may use a default mapping function or a discovered locality mapping function to assign an incoming write having a given key to a shard managed by the commit layer. For example, a default mapping function may assign the incoming write to a shard based on its key value and a key map that assigns keys based on key ranges or a hashing function, as a few examples. However, a discovered locality mapping function may append metadata to a data item when first written, the metadata may indicate the adjudicator (e.g. commit layer shard) to which the key was written. This metadata may be included with the data item when written into the storage layer. Thus, if the data item is later read as part of processing a query, this metadata will also be read, e.g. by a query processor. In a discovered locality scenario, the query processor then passes on metadata read for related data items when processing a given data item that is to be written. The discovered locality mapping function of the commit layer then selects an adjudicator (e.g. shard) to manage the given data item to be written taking into account which adjudicator(s) (e.g. shard(s)) have already been assigned to manage data items related to the given data item that is to be written. This system will result in related data items being clumped together and managed by the same adjudicators (e.g. belonging to similar commit layer shards) even though there is not readily apparent schema information indicating this locality included with the writes when written to the distributed database.

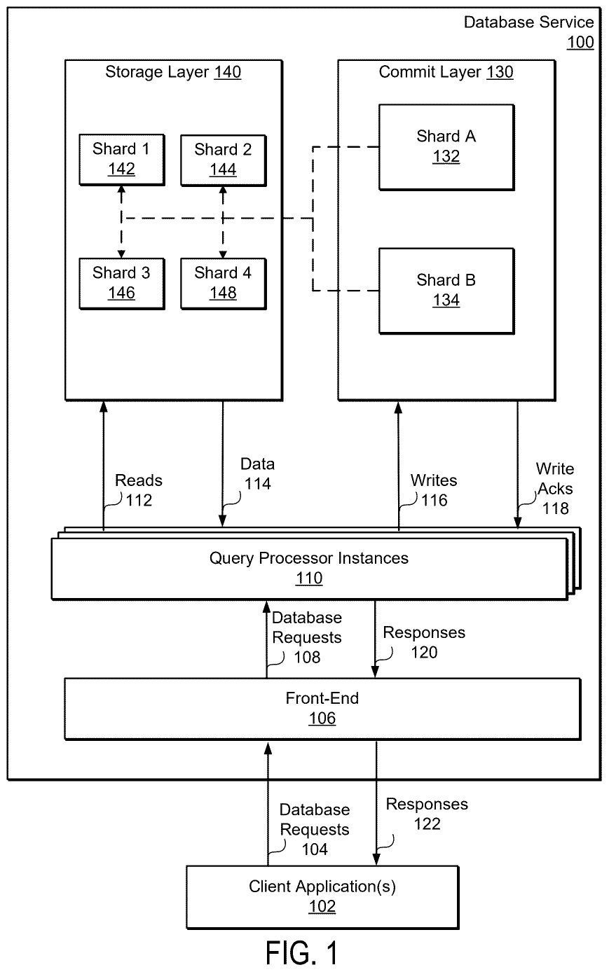

FIG. 1 is a block diagram illustrating a database service which includes a commit layer that manages commitment of writes using a first key sharding scheme and a corresponding first set of shards and a storage layer that stores data using a second key sharding scheme and a corresponding second set of shards, according to some embodiments.

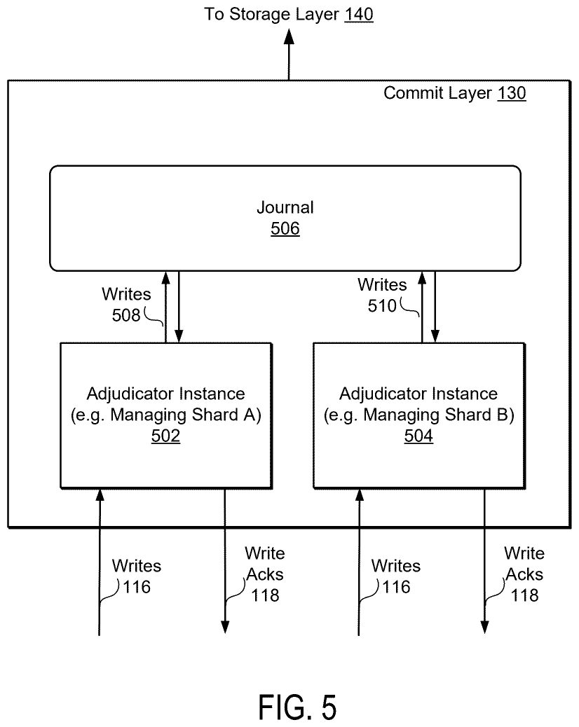

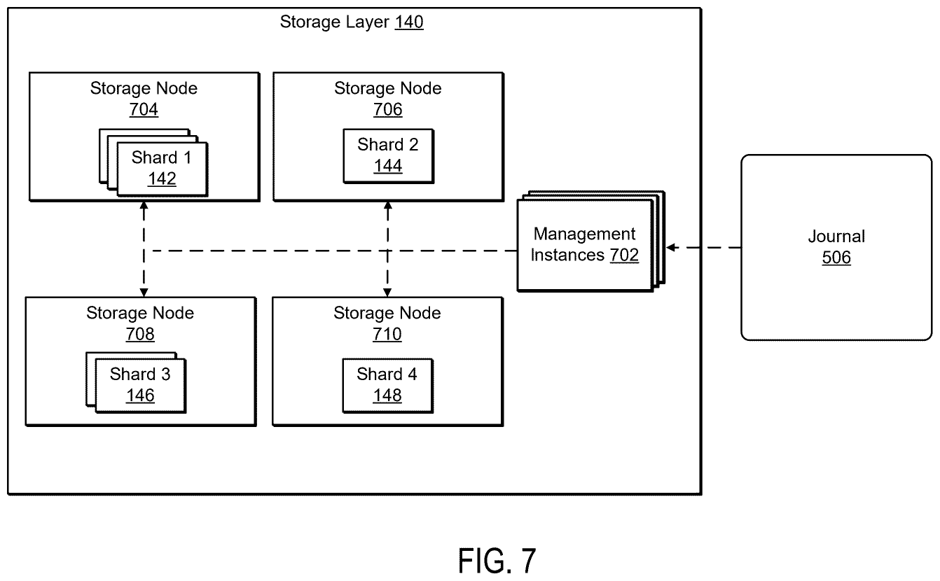

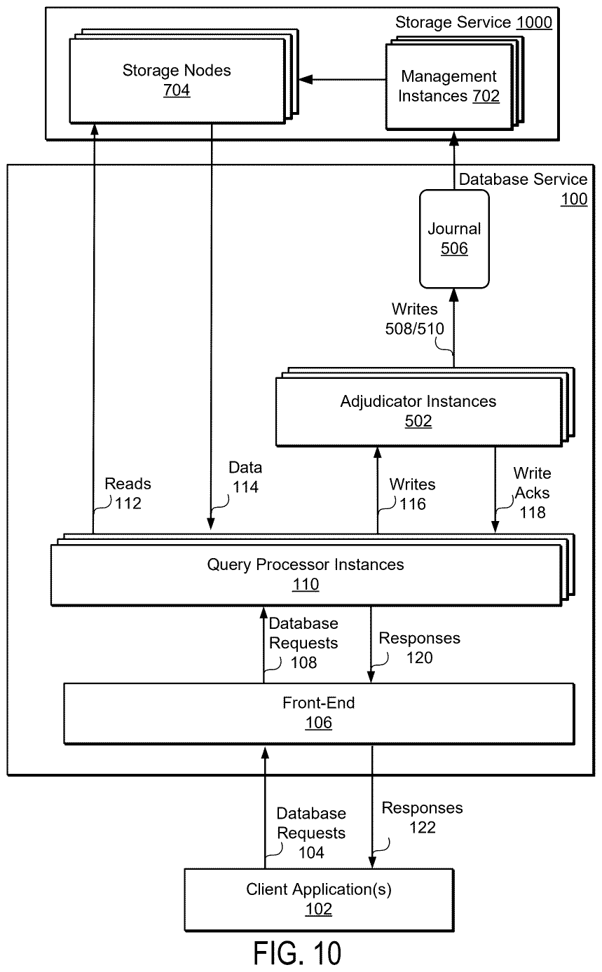

In some embodiments, a database service, such as database service 100 manages a storage a commit layer 130 and a storage layer 140. For example, storage nodes 704 and management instances 702 of storage service 700, as further described in FIGS. 7 and 10, may be used to implement storage layer 140. Also, adjudicator instances 502 and journal 506 may be used to implement commit layer 130, as further described in FIGS. 5-6 and 10.

One or more client application(s) 102 may store data to one or more databases maintained by a database service 100. Client application(s) 102 may submit database requests 104 (e.g., requests that cause reads, such as queries or read-only transactions, or requests that cause writes, such as updates, inserts, deletions, or transactions that include write statements) and receive responses 122 from front-end 106.

Front-end 106 may dispatch database requests 108 to a query processor instance 110, which may parse the request and interact with different components according to the type of request. For read requests, query processor instance 110 may rely upon a local cache and/or access storage layer 140 by submitting read requests 112 for data, which are returned as data 114 and used to respond to the read. For writes, write requests 116 may be sent to commit layer 130, which may determine whether a conflict exists and if not, writes are performed to journal and acknowledgments 118 are provided to query processor instance 110. Responses 120 may then be sent to front-end 106 for response 122 to client application(s) 102. Transactions may be applied from the commit layer 130 to the storage layer 140 asynchronously, e.g. at a time independent of the write acknowledgement 118, responses 120, and responses 122. For example, management instances that apply writes committed to the commit layer in the storage layer are further described in FIGS. 7 and 10.

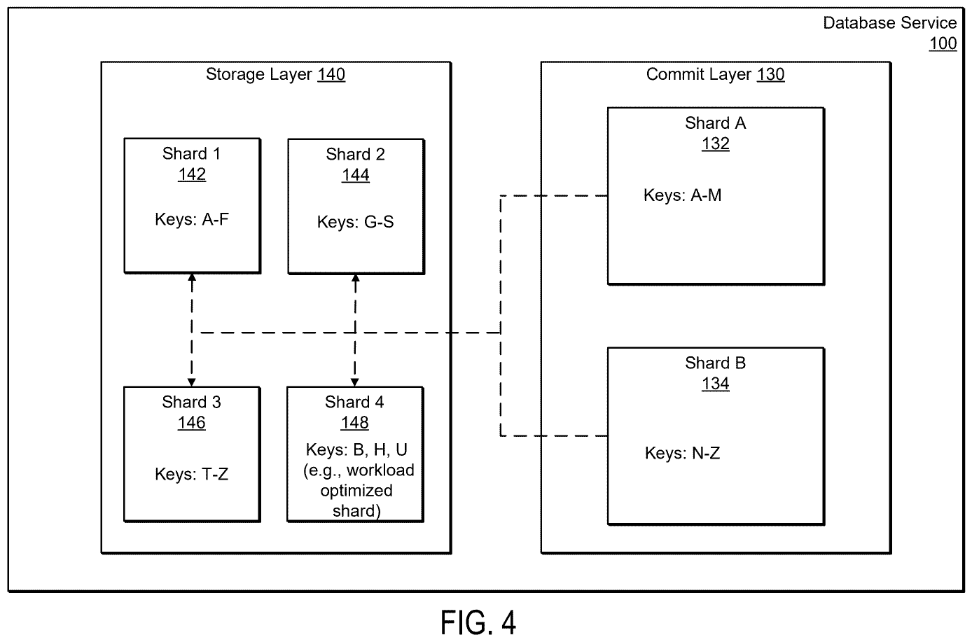

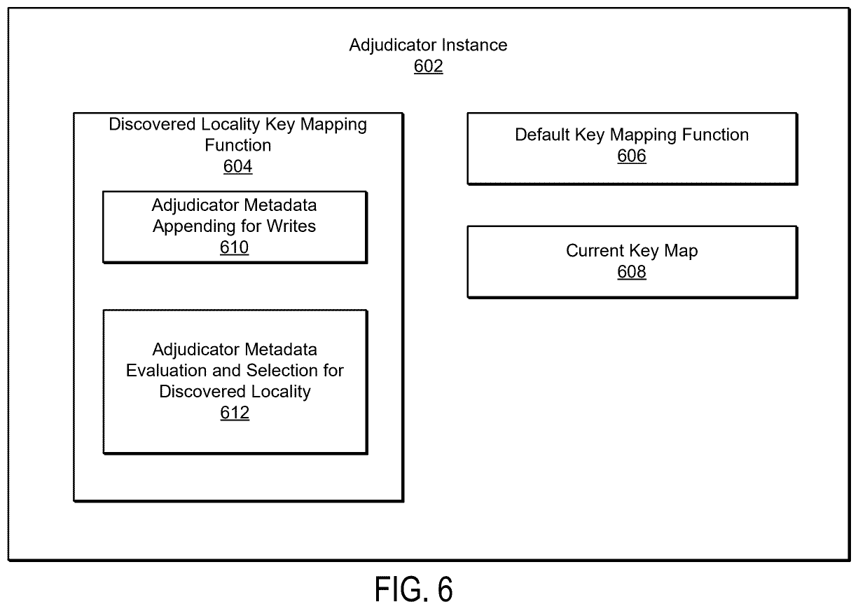

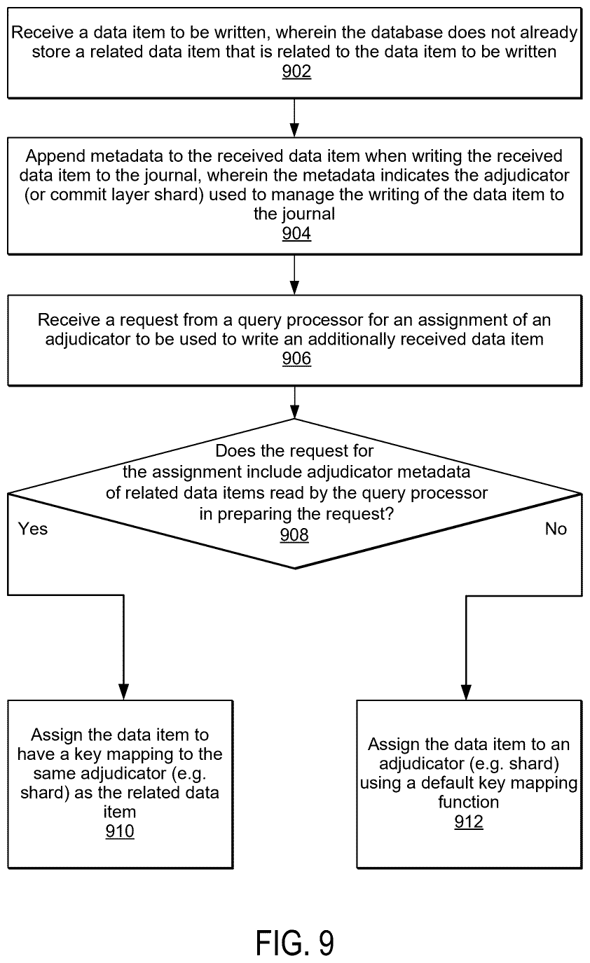

As can be seen in FIG. 1 commit layer 130 is sharded according to a first sharding scheme that shards the database data into shard A (132) and shard B (134). However, the storage layer 140 is sharded according to a second (independent) sharding scheme that shards the database data into shard 1 (142), shard 2 (144), shard 3 (146), and shard 4 (148). Not that various sharding techniques may be used such as range-based sharding wherein each shard includes a range of sequential keys or hash-based sharding wherein keys are assigned to shards based on a hashing function. Also, other sharding functions such as discovered locality, as discussed in FIGS. 6 and 9 may be used. Also, in some embodiments, workload optimized sharding functions may be used to determine shards included in the storage layer 140, such as described in FIG. 4.

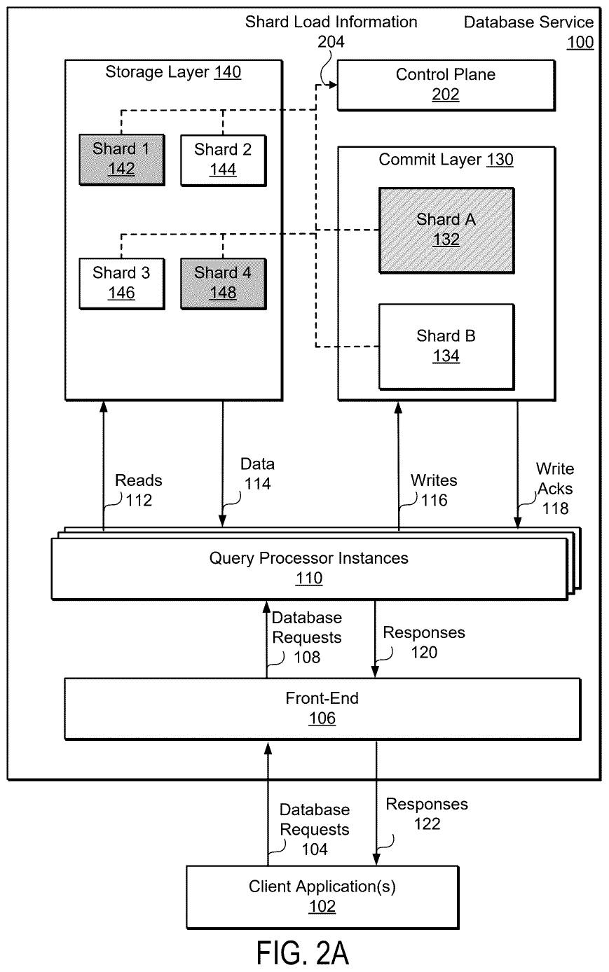

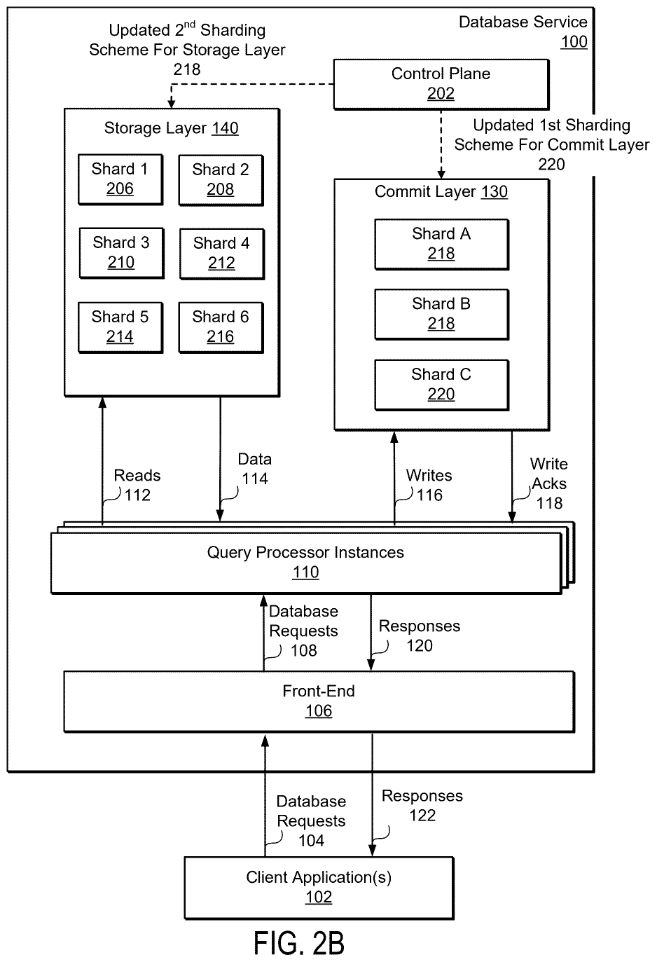

FIG. 2A is a block diagram illustrating a control plane monitoring the first set of shards of the commit layer and the second set of shards of the storage layer for shard heat, according to some embodiments.

In some embodiments, a control plane, such as control plane 202, for the database service 100, monitors the commit layer 130 and the storage layer 140 for shard heat. For example, a write load of the shards A (132) and B (134) of the commit layer may be monitored. Also, the request load of the shards 1 (142), 2 (144), 3 (146), and 4 (148) of the storage layer may be monitored. In some embodiments, the control plane 202 may periodically send health update requests to the respective shards of the commit layer 130 and the respective shards of the storage layer 140, and in response the shards may provide the control plane with health information such as load statistics.

In the example shown in FIG. 2B the shard load information 204 indicates that shard 1 (142) and shard 4 (148) of the storage layer 140 have a high request load. Also, the shard load information 204 indicates that shard A (132) of the commit layer 140 has a high write load.

FIG. 2B is a block diagram illustrating a re-sharding of the commit layer shards and a re-sharding of the storage layer shards, wherein different re-sharding schemes are used to re-shard the commit layer and the storage layer, respectively, according to some embodiments.

Based on the shard load information 204 received by the control plane 202 as shown in FIG. 2A, the control plane 202 provides storage layer 140 with an updated sharding scheme 218 and provides commit layer 130 with an updates sharding scheme 220. As can be seen the respective updated sharding schemes 218 and 220 cause the storage layer 140 to be re-sharded differently than the commit layer 130. Additionally, replicas of shards may be added to the storage layer to increase capacity to response to reads, wherein the commit layer is not required to mirror the storage layer and therefore does not include the replicas added to the storage layer.

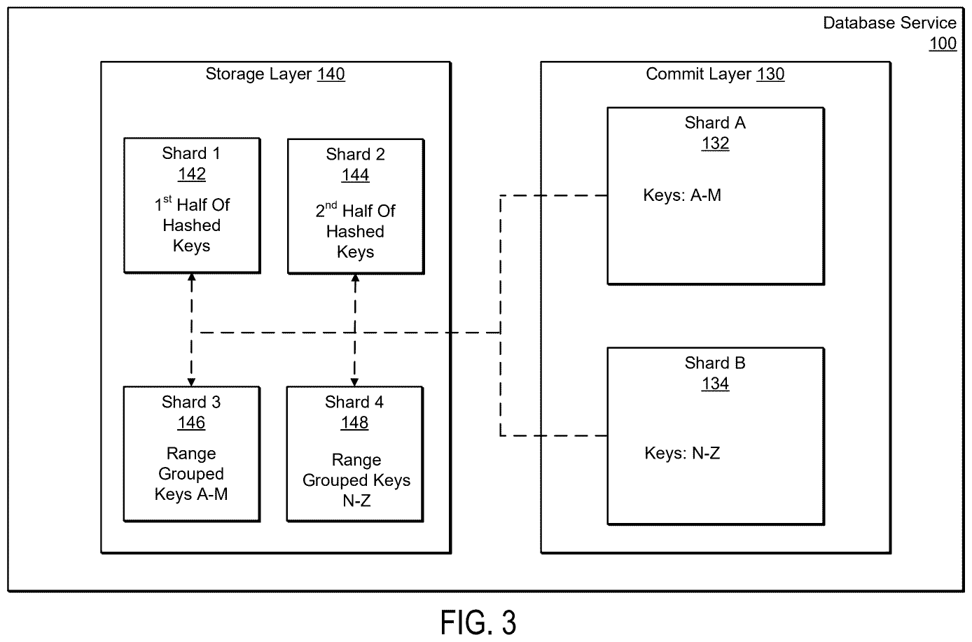

FIG. 3 is a block diagram illustrating example sharding schemes that may be used by the commit layer and the storage layer, wherein the sharding scheme used by the commit layer does not allow for overlap of keys between shards, and wherein the sharding scheme used by the storage layer allows for at least some keys to be included in multiple shards, according to some embodiments.

The adjudicator instances 502 (as further shown in FIG. 7) are responsible for managing writes (e.g. committing writes) for shards of the commit layer 130. In order to maintain consistency, each key is assigned to only one commit layer shard managed by one adjudicator instance 502. For example, as shown in FIG. 3 the keys are assigned by ranges, wherein shard A (132) is assigned keys A-M and shard B (134) is assigned keys N-Z. Note that in some embodiments, other key assignment techniques may be used (other than sequential ranges) as long as each key is only assigned to one shard in the commit layer 130. For example, a hash-based assignment scheme could alternatively be used in the commit layer, as long as keys were uniquely assigned to commit layer shards.

However, when the management instances 702 (as further shown in FIG. 7) move the committed data to storage, e.g. storage shards of the storage layer 140, the requirement that each key only belongs to one shard is relaxed. As shown in FIG. 3, a given key may be included in multiple shards of the storage layer. For example, for some types of queries having keys included in shards based on sequential ranges may provide more efficient query results, whereas for other types of queries having the keys hashed and assigned to shards in a more distributed manner may provide more efficient query results. Thus, in some embodiments, both key assignment techniques may be used to redundantly store data items for respective keys in different sets of shards that are organized differently in the storage layer 140, such as to be better configured for different types of queries. More specifically, storage layer 140 includes shards 1 and 2 (142 and 144) which store sets of keys grouped based on applying a hashing function, and storage layer 140 also includes shards 3 and 4 (146 and 148) which store range grouped sets of keys. In some embodiments, any deterministic function may be used to determine key to shard assignments. For example, a ranged-based scheme may include a function that assigns keys to shards and that takes as input the keys (or key ranges) directly, whereas a hash-based scheme may apply a hash function to the keys and then provide the hash function result as an input to the key to shard assignment function.

Hash-based schemes may be good for heat management as they are more likely to spread heat load across several shards. For example, if a set of sequential keys are read often (e.g. hot keys), a hash-based scheme may spread the read load for this set of sequential keys that are “hot keys” over several shards. A hash-based scheme may also be beneficial when performing a re-sharding, due to a minimal need to move keys between shards. For example, because keys are more evenly distributed with regard to heat load, more shards can be added in a hash-based scheme without a need to necessarily move each existing key to a new shard. Nevertheless, for some types of queries, hash-based schemes may be less efficient than other key-to-shard assignment schemes, such as range-based assignment schemes. For example, for queries that target large key ranges, a hash-based scheme may require reading data from a large number of shards, whereas the grouping of sequential keys in a range-based scheme may require reading from fewer shards. Also, queries targeting an open-ended range, such as keys greater than X, may be more efficiently performed using keys arranged according to a range-based key-to-shard mapping.

In some embodiments, as shown in FIG. 3, storage layer 140 includes shards that have keys arranged in the shards according to more than one key-to-shard mapping scheme. In such embodiments, a query processor instance 110, may select which set of shards to use to answer a given query based on the properties of the key arrangements in the respective shards. For example, if processing queries covering large ranges of keys, the query processor may direct reads for these types of queries to shards 3 and 4 (146 and 148), for example to take advantage of the benefits of having range grouped keys. As another example, for queries that require reading a large number of discrete keys (that are not necessarily sequential) the query processor instance 110 may direct reads for these types of queries to shards 1 and 2 (142 and 144), for example to take advantage of processor parallelization due to having the keys well distributed.

Also, in some embodiments, a query processor instance 110 may monitor (or otherwise understand) shard heat load and take shard heat load into account when selecting shards to be used to perform reads for a given query. For example, if shards 3 and 4 (146 and 148) are reported to be experiencing a high read load, and shards 1 and 2 (142 and 144) are lightly loaded, a query processor instance 110 may use the more lightly loaded shards to perform reads for a query type that would have otherwise been assigned to a different set of shards. For example, if the heat loading of shards 3 and 4 (146 and 148) negates the advantages of read efficiency due to range grouped keys, the query processor instance 110 may use shards 1 and 2 (142 and 144) to perform reads for a query that targets a medium size range of keys. For example, this may better balance load across the shards.

FIG. 4 is a block diagram illustrating example sharding schemes that may be used by the commit layer and the storage layer, wherein the storage layer includes one or more workload customized shards that include keys also included in one or more other shards of the storage layer, according to some embodiments.

In addition to, or as an alternative to, using the multiple key-to-shard mapping schemes described in FIG. 3, workload optimized shards may also be stored in the storage layer 140. For example, a workload optimized shard may include a group of keys that are often read together to perform a particular type of query. However, in contrast to the multiple key-to-shard mapping schemes described above which mapped each key to a shard in each of the key-to-shard mapping schemes, a workload optimized shard may only include a sub-set of keys needed for that workload. For example, FIG. 4 illustrates shards 1, 2, and 3 (142, 144, and 146) storing keys arranged according to a range-based key to shard mapping scheme. Note that all keys A-Z are accounted for in shards 1, 2, and 3 (142, 144, and 146). Also, keys B, H, and U are stored in workload optimized shard 4 (148). In contrast in the multiple key-to-shard mapping schemes described in FIG. 3, each of keys A-Z was included in two shards (once in the shards according to the hash-based key-to-shard mapping scheme and once in the shards according to the key range based key-to-shard mapping scheme). However, in FIG. 4, only keys B, H, and U are stored redundantly.

In some embodiments, multiple workload optimized shards storing keys arranged for different workloads may be stored together in the storage layer. For example, other types of shards similar to shard 4 (148) may be stored that are optimized for other workloads. These shards may include overlapping keys. For example, key H may be stored in shard 2 (144) and shard 4 (148) and potentially in another workload optimized shard.

In some embodiments, workload optimized shards may also be stored in a storage layer 140 that stores shards organized according to multiple key-to-shard mapping schemes such as described in FIG. 3. For example, a workload optimized shard may be stored as an additional shard in storage layer 140 in addition to the range-based shards and the hash-based shards shown in FIG. 3.

FIG. 5 is a block diagram illustrating components of the commit layer, according to some embodiments.

In some embodiments, commit layer 130 includes adjudicator instances 502 and 504 as well as journal 506. The journal maybe implemented using a separate journal service that at least partially redundantly stores data committed to the journal in a replicated way that erasure encodes stored data across multiple availability zones.

In some embodiments, a commit layer key-to-shard mapping is used (that may be different from the storage layer key-to-shard mappings). A query processor may access the commit layer mapping and may forward writes 116 to adjudicators based on this commit layer key-to shard mapping. For example, writes targeting keys included in shard A (132) may be sent to adjudicator instance 502, whereas writes targeting keys included in shard B (134) may be sent to adjudicator instance 504. Both adjudicator instance 502 and 504 may perform writes 508 and 510 to journal 506.

FIG. 6 is a block diagram illustrating example key mapping functions that may be used by an adjudicator instance of a commit layer in order to assign keys to particular shards managed by the commit layer, according to some embodiments.

In some embodiments, an adjudicator instance, such as described in FIGS. 5 and 10, may include components such as those shown for adjudicator instance 602, shown in FIG. 6. For example, adjudicator instance 602 includes a current key map 608, which may include mappings of keys to commit layer shards managed by respective ones of the adjudicator instances. Also, an adjudicator instance may include functions for determining key-to-shard mappings, such as a default key mapping function 606 and a discovered locality key mapping function 604. In some embodiments, discovered locality key mapping function 604 includes an appending mechanism 610 which appends metadata to writes when writing the writes to the journal. The metadata indicates which commit layer shard/adjudicator was used to commit the write. Even once the write gets moved to the storage layer, the metadata stays with the write and is returned to a query processor when the write is later read. The query processor then passes the metadata to the adjudicator when performing another write for a related data item, such as another write to the same row as the original write. The adjudicator instance then uses this metadata, via evaluator 612, to make a shard assignment for the subsequent write based on the shard that was used in the commit layer for the related write. For example, the subsequent write and the original write may be assigned to the same shard. In this way, locality of writes may be discovered over time due to the writes having a relationship to other writes that have already been written. Note that the locality is discovered because the relationship is not explicitly provided in the data being written. Instead, the locality is discovered due to a transaction for a later piece of data causing a previously stored piece of data to be read (along with its locality metadata).

FIG. 7 is a block diagram illustrating components of the storage layer, according to some embodiments.

In some embodiments, storage layer 140 includes storage nodes that provide an execution environment for performing reads to data stored in shards, such as storage nodes 704, 706, 708, and 710, which manage shards 1 (142) (e.g. shard 1 and replicas of shard 1), shard 2 (144), shards 3 (146) (e.g. shard 3 and a replica of shard 3), and shard 4 (148). In some embodiments, management instances 702 order writes committed to journal 702 based on sequence numbers and then cause the writes to be written from the journal to respective ones of the shards based on a storage layer key-to-shard mapping. In some embodiments, storage nodes 704, 706, 708, and 710 may be containerized execution environments, virtual machines, etc. In some embodiments, multiple storage nodes may be implemented on shared storage host computing devices. Also, in some embodiments, multiple shards may be managed by a shared storage node. Note that while in FIG. 7 each shard (and its replicas) is managed by a different storage node, in some embodiments, multiple different shards may be managed by the same storage node and replicas of shards may be distributed to be managed by multiple storage nodes.

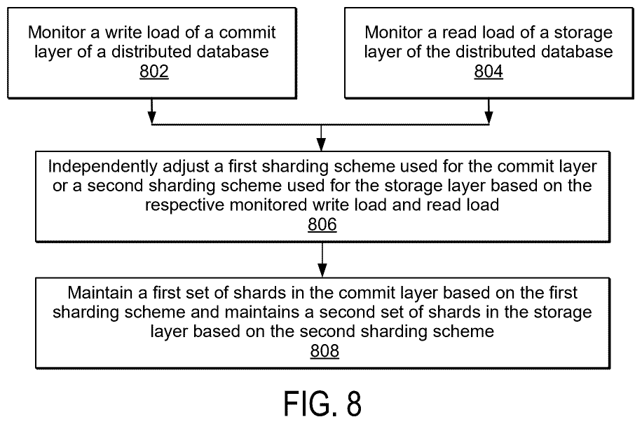

FIG. 8 is a flowchart for a process for monitoring write and read heat load and re-sharding the commit layer and/or the storage layer of a distributed database based on the monitored write loads and heat loads, according to some embodiments.

At block 802 a control plane of a distributed database system monitors a write load of components of a commit layer, such as a load of adjudicator instances. Also, at block 804, the control plane monitors a read load of components of the storage layer, such as storage nodes of the storage layer.

At block 806, the control plane independently adjusts a first sharding scheme used for the commit layer or a second sharding scheme used for the storage layer based on the respective monitored write load and read load. For example, the storage layer sharding scheme may be adjusted to add more shards without having to adjust the sharding scheme for the commit layer. Likewise, the storage layer sharding scheme may be adjusted in a different way than the commit layer. For example, different numbers of shards or replicas may be added to either the storage layer or the commit layer independent of the shard adjustments made to the other one of the layers.

At block 808, the control plane maintains a first set of shards in the commit layer based on the first sharding scheme and maintains a second set of shards in the storage layer based on the second sharding scheme.

FIG. 9 is a flowchart for a process for determining a shard (e.g. adjudicator) to which a key is to be assigned based on discovered locality, according to some embodiments.

At block 902, an adjudicator instance receives a data item to be written, wherein the database does not already store a related data item that is related to the data item to be written. For example, an adjudicator instance may receive a first entry for a given row of the database.

At block 904, the adjudicator instance appends metadata to the received data item when writing the received data item to the journal, wherein the metadata indicates the adjudicator (or commit layer shard) used to manage the writing of the data item to the journal.

At block 906, the adjudicator instance receives a request from a query processor for an assignment of an adjudicator to be used to write an additionally received data item. For example, the query processor may have needed to read the first stored data item to process the query for the related data item, in which case the adjudicator assignment data is read by the query processor when reading the first data item and is passed along with the write for the related data item. For example, the related data item may belong to a same row as the first data item.

At block 908, the adjudicator instance determines whether the request for the assignment (for the related data item) includes adjudicator metadata read by the query processor in preparing the request for an adjudicator assignment for the related data item.

If so, then at block 910, the adjudicator instance assigns the related data item to have a same key-to-shard mapping as the first data item. For example, the key for the related data item is assigned to the same commit layer shard as the key for the first data item.

If not, then at block 912, the adjudicator instance assigns the second data item to an adjudicator using a default key mapping function, such as default key mapping function 606, which may be a range-based key-to-shard mapping function, a hash-based key-to-shard mapping, or other suitable key-to-shard mapping which ensures that, at the commit layer, each key is assigned to only one shard.

FIG. 10 is a block diagram illustrating various components of a database service and storage service that host a distributed database, according to some embodiments.

One or more client application(s) 102 may store data to one or more databases maintained by a database service 100. Client application(s) 102 may submit database requests 104 (e.g., requests that cause reads, such as queries or read-only transactions, or requests that cause writes, such as updates, inserts, deletions, or transactions that include write statements) and receive responses 122 from front-end 106.

Front-end 106 may dispatch database requests 108 to a query processor instance 110, which may parse the request and interact with different components according to the type of request. For read requests, query processor instance 110 may rely upon a local cache and/or access storage nodes 704 by submitting read requests 112 for data, which are returned as data 114 and used to respond to the read. For writes, write requests 116 may be sent to an adjudicator instances 502, which may determine whether a conflict exists and if not, writes 508/510 are performed to journal 506 and acknowledges the write 118 to query processor instance 110. Responses 120 may then be sent to front-end 106 for response 122 to client application(s) 102. Transactions may be applied to the database by management instances 702, at a time independent of the write acknowledgement 118, responses 120, and responses 122.

Database service 100 may implement a fleet of host computing devices which may provide, in various embodiments, a multi-tenant configuration so that different query processor instances, such as query processor instances 110 and other query processors, can be hosted on the same host computing machine, but provide access to different databases on behalf of different clients over different connections. In some embodiments, hosts systems may not be multi-tenant and a single virtual machine may implement a single query processor instance 110 which may provide access to a single database for a single client.

In some embodiments, database data for a database of database service 100 may be stored in a separate storage service 1000. In some embodiments, storage service 1000 may be implemented to store database data as virtual disk or other persistent storage drives. In some embodiments, embodiments, storage service 1000 may store data for databases using tree structured storage and log structured storage.

For example, data may be organized in various logical volumes, segments, and pages for storage on one or more storage nodes 704 of storage service 1000. For example, in some embodiments, each database may be represented by a logical volume, and each logical volume may be segmented into storage partitions over a collection of storage nodes 704. A storage partition may be an individual component that an individual query processor instance 110, for example, may communicate with. Each storage partition, which may be hosted on a particular one of the storage nodes, may contain a set of contiguous block addresses, in some embodiments. Moreover, as discussed above, each storage node may store a given shard according to a storage layer sharding scheme. Also, the storage layer sharding scheme may different from a sharding scheme used by the commit layer to manage which adjudicators are responsible for performing writes for which keys.

In at least some embodiments, storage nodes 704 may provide multi-tenant storage so that data stored in a storage partition of one storage device may be stored for a different database, database user, account, or entity than data stored in another storage partition on the same storage device (or other storage devices) of the same storage node 704. Various access controls and security mechanisms may be implemented, in some embodiments, to ensure that data is not accessed at a storage node 704 except for authorized requests (e.g., for users authorized to access the database, owners of the database, etc.). For example, a cluster of database components may correspond to a particular database, and may use tokens specific to the cluster to identify and encrypt data.

In some embodiments, each storage partition may store a collection of one or more data pages and a change log (also referred to as a redo log) (e.g., a log of redo log records) for each data page that it stores. Storage nodes 704 may receive redo log records and coalesce them to create new versions of the corresponding data and/or additional or replacement log records (e.g., lazily and/or in response to a request for data or a database crash). In some embodiments, data and/or change logs may be mirrored across multiple storage nodes 704, according to a variable configuration (which may be specified by the client on whose behalf the database is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, journal 506, which may be a logical journal, may be hosted in database service 100 that stores ordered updates to the database (e.g., to a database volume). Adjudicator instances 502 may be responsible for deciding whether transactions or writes can be committed (while following isolation rules), for working with database journal 506 to order transactions, and for ensuring that committed data is consistent. Management instances 702, which may be a logical crossbar server, may apply updates to the database stored at the storage nodes 704 from the database journal 506 as directed by the adjudicator instances 502.

Front-end 106 may implement a proxy, request router, or other load balancing feature that routes database requests to one or more query processor instances 110. For example, front-end 106 may be responsible for authenticating requests to connect to a database at a particular network endpoint and allocating a query processor instance 110 to the connection (or to a particular request such as a read or a write). The front-end 106 may maintain the connection (e.g., as a proxy) so that if different query processor instances 110 are used for different requests to the database, separate connections do not have to be established.

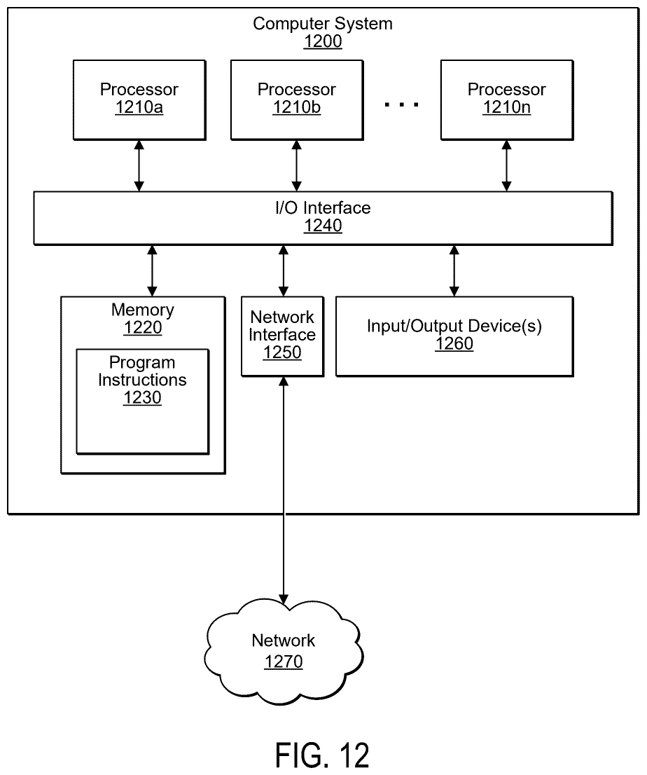

Database service 100 may implement a control plane which may manage the creation, provisioning, deletion, or other features of managing a database hosted in database service 100. For example, the control plane may monitor the performance of host computing devices (e.g., a computing system or device like computing system 1200 discussed below with regard to FIG. 12) for high workloads (e.g., heat) and move or redirect placement of database engine head node instances away from some host computing devices to avoid overburdening host computing devices. The control plane may handle various management requests, such as requests to create databases or manage databases (e.g., by configuring or modifying performance), such as by enabling a “serverless” or other automated management feature in response to a request which may cause in-place resource scaling to be enabled for that database. The control plane may direct placement of database engine head node instances on host computing devices so as to distribute workload across host computing devices to avoid failure scenarios, like out-of-memory. As discussed above, the control plane may maintain different sharding schemes for the commit layer and the storage layer and may independently re-shard the storage layer, the commit layer, or both based on changes in heat loading of the respective shards of the storage layer and the commit layer.

Database service 100 may implement one or more different types of database systems with respective query processor instances 110 for accessing database data as part of the database. For example, database service 100 may implement various types of connection-based (e.g., having established a network connection between a database client and query processor instances 110 on a database host system) database systems which may, for instance, facilitate the performance of various operations that continue over multiple communications between the database client and the connected query processor instance 110. In at least some embodiments, database service 100 may be a relational database service that hosts relational databases on behalf of clients.

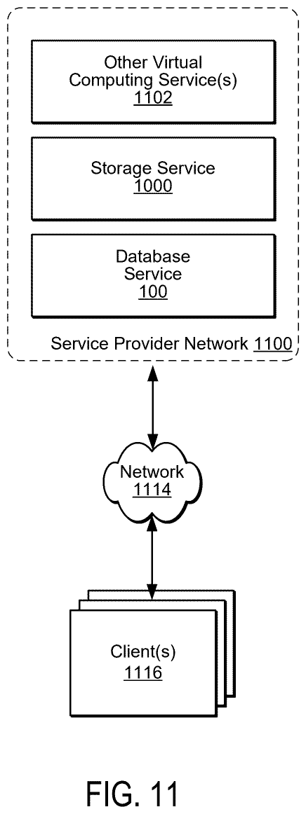

FIG. 11 is a block diagram illustrating a provider network that may implement database services that implement techniques described herein, according to some embodiments.

A service provider network 1100 (sometimes referred to as a “cloud provider network” or “cloud”) refers to a pool of network-accessible computing resources (such as compute, storage, and networking resources, applications, and services), which may be virtualized or bare-metal. The service provider network 1100 can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network 1114 (e.g., the Internet, a cellular communication network) and the hardware and software in cloud provider data centers that provide those services.

A service provider network 1100 can be formed as a number of regions, where a region is a separate geographical area in which the cloud provider clusters data centers. Each region can include two or more availability zones connected to one another via a private high-speed network, for example, a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the provider network via a publicly accessible network (e.g., the Internet, a cellular communication network) by way of a transit center (TC). TCs can be considered as the primary backbone locations linking users to the provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The provider network may deliver content from points of presence outside of, but networked with, these regions by way of edge locations and regional edge cache servers (points of presence, or PoPs). This compartmentalization and geographic distribution of computing hardware enables the provider network to provide low-latency resource access to users on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the provider network, which may be provisioned in user accounts.

The traffic and operations of the provider network may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

An exemplary provider network may include numerous provider network regions and so on that may include one or more data centers hosting various resource pools, such as collections of physical and/or virtualized computer servers, storage devices, networking equipment and the like (e.g., computing system 1200 described below with regard to FIG. 12), needed to implement and distribute the infrastructure and storage services offered by the provider network within the provider network regions.

As illustrated in FIG. 11, a number of clients (shown as clients 1116) may interact with a service provider network 1100 via a network 1114. Service provider network 1100 may implement respective instantiations of the same (or different) services, such as a database service 100 for a first region and a second instantiation of database service 100 for a second region, and so on. Similar arrangements may be implemented for storage service 1000, as well as various other virtual computing services 1102. It is noted that where one or more instances of a given component may exist, reference to that component herein may be made in either the singular or the plural. However, usage of either form is not intended to preclude the other.

In various embodiments, the components illustrated in FIG. 11 may be implemented directly within computer hardware, as instructions directly or indirectly executable by computer hardware (e.g., a microprocessor or computer system), or using a combination of these techniques. For example, the components of FIG. 11 may be implemented by a system that includes a number of computing nodes (or simply, nodes), each of which may be similar to the computer system embodiment illustrated in FIG. 12 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 1116 may encompass any type of client configurable to submit network-based services requests to service provider network 1100 via network 1114, including requests for database services. For example, a given client 1116 may include a suitable version of a web browser, or may include a plug-in module or other type of code module that may execute as an extension to or within an execution environment provided by a web browser. Alternatively, a client 1116 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 1116 may be an application which may interact directly with service of a region of a provider network. In some embodiments, client 1116 may generate network-based services requests according to a Representational State Transfer (REST)-style web services architecture, a document-based or message-based network-based services architecture, or another suitable network-based services architecture. Although not illustrated, some clients of service provider network 1100 services may be implemented within a service of the provider network (e.g., a client application of database service 100 may be implemented on one of other virtual computing service(s) 1102), in some embodiments. Therefore, various examples of the interactions discussed with regard to clients 1116 may be implemented for internal clients as well, in some embodiments.

In some embodiments, a client 1116 (e.g., a database service client) may be provided access to network-based storage of database data to other applications in a manner that is transparent to those applications. For example, client 1116 may be integrated with an operating system or file system to provide storage in accordance with a suitable variant of the storage models described herein. However, the operating system or file system may present a different storage interface to applications, such as a conventional file system hierarchy of files, directories, and/or folders. In such an embodiment, applications may not need to be modified to make use of the storage system service model, as described above. Instead, the details of interfacing to the provider network may be coordinated by client 1116 and the operating system or file system on behalf of applications executing within the operating system environment.

Clients 1116 may convey network-based services requests to and receive responses from a region of the provider network via network 1114. In various embodiments, network 1114 may encompass any suitable combination of networking hardware and protocols necessary to establish network-based communications between clients 1116 and a service provider network 1100. For example, network 1114 may generally encompass the various telecommunications networks and service providers that collectively implement the Internet. Network 1114 may also include private networks such as local area networks (LANs) or wide area networks (WANs) as well as public or private wireless networks. For example, both a given client 1116 and the provider network region may be respectively provisioned within enterprises having their own internal networks. In such an embodiment, network 1114 may include the hardware (e.g., modems, routers, switches, load balancers, proxy servers, etc.) and software (e.g., protocol stacks, accounting software, firewall/security software, etc.) necessary to establish a networking link between given client 1116 and the Internet as well as between the Internet and a provider network. It is noted that in some embodiments, clients 1116 may communicate with regions of a provider network using a private network rather than the public Internet. For example, clients 1116 may be provisioned within the same enterprise as a database service. In such a case, clients 1116 may communicate with a provider network region entirely through a private network 1114 (e.g., a LAN or WAN that may use Internet-based communication protocols but which is not publicly accessible).

Generally speaking, service provider network 1100 may implement one or more service endpoints which may receive and process network-based services requests, such as requests to access a database (e.g., queries, inserts, updates, etc.) and/or manage a database (e.g., create a database, configure a database, etc.). For example, a provider network region may include hardware and/or software which may implement a particular endpoint, such that an HTTP-based network-based services request directed to that endpoint is properly received and processed. In one embodiment, a provider network region may be implemented as a server system may receive network-based services requests from clients 1116 and to forward them to components of a system that implements database service 100, storage service 1000, and/or another virtual computing service 1102 for processing. In other embodiments, provider network region may be configured as a number of distinct systems (e.g., in a cluster topology) implementing load balancing and other request management features may dynamically manage large-scale network-based services request processing loads. In various embodiments, a provider network region may support REST-style or document-based (e.g., SOAP-based) types of network-based services requests.

In addition to functioning as an addressable endpoint for clients'network-based services requests, in some embodiments, a service provider network 1100 may implement various client management features. For example, service provider network 1100 may coordinate the metering and accounting of client usage of network-based services, including storage resources, such as by tracking the identities of requesting clients 1116, the number and/or frequency of client requests, the size of data tables (or records thereof) stored or retrieved on behalf of clients 1116, overall storage bandwidth used by clients 1116, class of storage requested by clients 1116, or any other measurable client usage parameter. Provider network regions may also implement financial accounting and billing systems, or may maintain a database of usage data that may be queried and processed by external systems for reporting and billing of client usage activity. In certain embodiments, provider network regions may collect, monitor and/or aggregate a variety of storage service system operational metrics, such as metrics reflecting the rates and types of requests received from clients 1116, bandwidth utilized by such requests, system processing latency for such requests, system component utilization, such as the target capacity determined for individual database engine head node instances, network bandwidth and/or storage utilization, rates and types of errors resulting from requests, characteristics of storage and databases (e.g., size, data type, etc.), or any other suitable metrics. In some embodiments, such metrics may be used by system administrators to tune and maintain system components, while in other embodiments such metrics (or relevant portions of such metrics) may be exposed to clients 1116 to enable such clients to monitor their usage of database service 100, storage service 1000 and/or another virtual computing service 1102 (or the underlying systems that implement those services).

In some embodiments, provider network regions may also implement user authentication and access control procedures. For example, for a given network-based services request to access a particular database table, a provider network region may ascertain whether the client 1116 associated with the request is authorized to access the particular database table. Provider network regions may determine such authorization by, for example, evaluating an identity, password or other credential against credentials associated with the particular database table, or evaluating the requested access to the particular database table against an access control list for the particular database table. For example, if a client 1116 does not have sufficient credentials to access the particular database table, the provider network region may reject the corresponding network-based services request, for example by returning a response to the requesting client 1116 indicating an error condition. Various access control policies may be stored as records or lists of access control information by database services 100, storage services 1000, and /r other virtual computing services 1102.

Note that in many of the examples described herein, services, like database service 100 or storage service 1000 may be internal to a computing system or an enterprise system that provides database services to clients 1116, and may not be exposed to external clients (e.g., users or client applications). In such embodiments, the internal “client” (e.g., database service 100) may access storage service 1000 over a local or private network (e.g., through an API directly between the systems that implement these services). In such embodiments, the use of storage service 1000 in storing database storage structures on behalf of clients 1116 may be transparent to those clients. In other embodiments, storage service 1000 may be exposed to clients 1116 through service provider network 1100 to provide storage of database tables or other information for applications other than those that rely on database service 100 for database management. In such embodiments, clients of the storage service 1000 may access storage service 1000 via network 1114 (e.g., over the Internet). In some embodiments, a virtual computing service 1102 may receive or use data from storage service 1000 (e.g., through an API directly between the virtual computing service 1102 and storage service 1000) to store objects used in performing computing services 1102 on behalf of a client 1116. In some cases, the accounting and/or credentialing services of provider network region may be unnecessary for internal clients such as administrative clients or between service components within the same enterprise.

### Example Computer System

FIG. 12 is a block diagram illustrating an example computer system that implements some or all of the techniques described herein, according to some embodiments.

FIG. 12 illustrates exemplary computer system 1200 usable to implement the processor allocator as described above with reference to FIGS. 1-11. In different embodiments, computer system 1200 may be any of various types of devices, including, but not limited to, a network computer, a mobile device, a consumer device, application server, storage device, a peripheral device such as a switch, modem, router, or in general any type of computing or electronic device.

Various embodiments of program instructions for a processor allocator 1230, as described herein, may be executed in one or more computer systems 1200, which may interact with various other devices. Note that any component, action, or functionality described above with respect to FIGS. 1-11 may be implemented on one or more computers configured as computer system 1200 of FIG. 12, according to various embodiments. In the illustrated embodiment, computer system 1200 includes one or more processors 1210 coupled to a system memory 1220 via an input/output (I/O) interface 1240. Computer system 1200 further includes a network interface 1250 coupled to I/O interface 1240, and one or more input/output devices 1260. In some cases, it is contemplated that embodiments may be implemented using a single instance of computer system 1200, while in other embodiments multiple such computer systems, or multiple nodes making up computer system 1200, may be configured to host different portions or instances program instructions as described above for various embodiments. For example, in one embodiment some elements of the program instructions may be implemented via one or more nodes of computer system 1200 that are distinct from those nodes implementing other elements.

In some embodiments, computer system 1200 may be implemented as a system on a chip (SoC). For example, in some embodiments, processors 1210, memory 1220, I/O interface 1240 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 1220 may be configured to store compression or decompression program instructions for a processor allocator 1230 accessible by one or more of the processors 1210. In various embodiments, system memory 1220 may be implemented using any suitable memory technology, such as static random-access memory (SRAM), synchronous dynamic RAM (SDRAM), nonvolatile/Flash-type memory, or any other type of memory. In the illustrated embodiment, program instructions for a processor allocator 1230 may be configured to implement any of the functionality described above. In some embodiments, program instructions and/or data may be received, sent, or stored upon different types of computer-accessible media or on similar media separate from system memory 1220 or computer system 1200.

In one embodiment, I/O interface 1240 may be configured to coordinate I/O traffic between processor 1210, system memory 1220, and any peripheral devices in the device, including network interface 1250 or other peripheral interfaces, such as input/output devices 1260. In some embodiments, I/O interface 1240 may perform any necessary protocol, timing, or other data transformations to convert data signals from one component (e.g., system memory 1220) into a format suitable for use by another component (e.g., processor 1210). In some embodiments, I/O interface 1240 may include support for devices attached through various types of peripheral buses, such as a variant of the Peripheral Component Interconnect (PCI) bus standard or the Universal Serial Bus (USB) standard, for example. In some embodiments, the function of I/O interface 1240 may be split into two or more separate components, such as a north bridge and a south bridge, for example. Also, in some embodiments, some or all of the functionality of I/O interface 1240, such as an interface to system memory 1220, may be incorporated directly into processor 1210.

Network interface 1250 may be configured to allow data to be exchanged between computer system 1200 and other devices attached to a network 1270 (e.g., carrier or agent devices) or between nodes of computer system 1200. Network 1270 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1250 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1260 may, in some embodiments, include one or more display terminals, keyboards, keypads, touchpads, scanning devices, voice or optical recognition devices, or any other devices suitable for entering or accessing data by one or more computer systems 1200. Multiple input/output devices 1260 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1250.

As shown in FIG. 12, memory 1220 may include program instructions for a processor allocator 1230, which may be processor-executable to implement any element or action described above. In one embodiment, the program instructions may implement the methods described above. In other embodiments, different elements and data may be included.

Computer system 1200 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A system, comprising:
a first set of computing devices configured to implement a commit layer for a distributed database, wherein the first set of computing devices are configured to:
durably commit a write in the distributed database; and
provide, in response to durably committing the write, a commitment response indicating the write has been committed in the distributed database;
a second set of computing devices configured to implement a storage layer for the distributed database, wherein the second set of computing devices are configured to:
store or retrieve data stored in the distributed database in response to a read or write request,
wherein:
the first set of computing devices configured to implement the commit layer are configured to manage shards of data stored in the distributed database that are sharded according to a first sharding scheme;
the second set of computing devices configured to implement the storage layer are configured to store shards of data stored in the distributed database that are sharded according to a second sharding scheme; and
shards according to the first sharding scheme include combinations of keys for data stored in the distributed database that are different from combinations of keys included in shards sharded according to the second sharding scheme.

2. The system of claim 1, further comprising:
one or more computing devices configured to implement a control plane for the distributed database, wherein the control plane is configured to:
monitor a write load of the commit layer;
monitor a read load of the storage layer; and
independently adjust the second sharding scheme used by the storage layer independent of the first sharding scheme used by the commit layer; or
independently adjust the first sharding scheme used by the commit layer independent of the second sharding scheme used by the storage layer.

3. The system of claim 1, wherein the first set of computing devices that are configured to implement the commit layer are further configured to implement:
two or more adjudicators,
wherein respective ones of the two or more adjudicators are responsible for managing writes for respective ones of the shards that have been sharded according to the first sharding scheme, and
wherein a respective adjudicator responsible for managing writes for a respective shard provides the commitment response indicating the write has been committed in the distributed database is in response to causing the write to be successfully written to a journal associated with the respective adjudicator.

4. The system of claim 1, wherein the second set of computing devices configured to implement the storage layer are further configured to implement:
a plurality of storage nodes, wherein one or more of the storage nodes store keys corresponding to a given one of the shards that have been sharded according to the second sharding scheme; and
one or more storage management instances configured to read committed writes from a journal and assign given ones of the committed writes to a given one or more of the storage nodes based on a key to shard mapping in accordance with the second sharing scheme.

5. The system of claim 1, further comprising:
one or more computing devices configured to implement query processors for the distributed database, wherein respective ones of the query processors are configured to:
connect to clients of the distributed database; and
process queries submitted by the clients of the distributed database, wherein:
write transactions included in the queries are directed to the first set of computing devices implementing the commit layer; and
read transactions included in the queries are directed to the second set of computing devices implementing the storage layer.

6. The system of claim 5, wherein the read transactions are processed independent of the commit layer.

7. The system of claim 1, wherein adjudicators of the commit layer are configured to:
append metadata to data items written to the journal indicating which shard of the first sharding scheme the given data items belong to; and
in response to receiving additional data items to write that are related to data items that have already been written,
retrieve a given related data item that is related to a given data item being written; and
determine a shard of the first sharding scheme to which to assign the given data item being written based on the metadata of the retrieved related data item.

8. A method, comprising:
monitoring a write load of a commit layer of a distributed database;
monitoring a read load of a storage layer of the distributed database; and
independently adjusting a second sharding scheme used by the storage layer independent of a first sharding scheme used by the commit layer; or
independently adjusting the first sharding scheme used by the commit layer independent of the second sharding scheme used by the storage layer,
wherein shards according to the first sharding scheme include combinations of keys for data stored in the distributed database that are different from combinations of keys included in shards sharded according to the second sharding scheme.

9. The method of claim 8, wherein the second sharding scheme used by the storage layer includes a greater number of shards than the first sharding scheme used by the commit layer for a same range of keys of the distributed database.

10. The method of claim 8, wherein at least some of the shards according to the second sharding scheme include a same key, and wherein none of the shards according to the first sharding scheme include a same key.

11. The method of claim 10, wherein the at least some of the shards according to the second sharding scheme that include the same key comprise:
a first shard comprising a first combination of keys selected for use in processing a first type of query workload; and
a second shard comprising another combination of keys selected for use in processing a second type of query workload, wherein:
the first and second combinations of keys include at least some of the same keys; and
the first and second combinations of keys include at least some different keys.

12. The method of claim 8, further comprising:
appending metadata to data items written to a journal indicating which shard of the first sharding scheme the given data items belong to; and
in response to receiving additional data items to write that are related to data items that have already been written,
retrieving a given related data item that is related to a given data item being written; and
determining a shard of the first sharding scheme to which to assign the given data item being written based on the metadata of the retrieved related data item.

13. The method of claim 12, further comprising:
in response to receiving other additional data items to write that are not associated with a row of data items have already been written,
determining a shard of the first sharding scheme to which to assign the other additional data items based on a shard map for the first sharding scheme.

14. The method of claim 8, wherein the commit layer is implemented using:
two or more adjudicators,
wherein respective ones of the two or more adjudicators are responsible for managing writes for respective ones of the shards that have been sharded according to the first sharding scheme, and
wherein a respective adjudicator responsible for managing writes for a respective shard provides the commitment response indicating the write has been committed in the distributed database is in response to causing the write to be successfully written to a journal associated with the respective adjudicator.

15. The method of claim 8, further comprising:
connecting to clients of the distributed database using one or more query processors; and
processing queries submitted by the clients of the distributed database using the one or more query processors, wherein:
write transactions included in the queries are directed to a first set of computing devices implementing the commit layer; and
read transactions included in the queries are directed to a second set of computing devices implementing the storage layer.

16. The method of claim 15, wherein the write transactions are processed by one or more adjudicators of the commit layer and written to a journal of the commit layer.

17. The method of claim 16, wherein the read transactions are processed by one or more storage nodes of the storage layer and bypass the adjudicators of the commit layer.

18. One or more non-transitory, computer-readable storage media, storing program instructions that, when executed using one or more computing devices, cause the one or more computing devices to:
monitoring a read load of a commit layer of a distributed database;
monitoring a request load of a storage layer of the distributed database; and
independently adjust a second sharding scheme used by the storage layer independent of a first sharding scheme used by the commit layer; or
independently adjust the first sharding scheme used by the commit layer independent of the second sharding scheme used by the storage layer,
wherein shards according to the first sharding scheme include combinations of keys that are different from combinations of keys included in shards sharded according to the second sharding scheme.

19. The one or more non-transitory, computer-readable storage media of claim 18, wherein the second sharding scheme used by the storage layer incudes a greater number of shards than the first sharding scheme used by the commit layer for a same range of keys of the distributed database.

20. The one or more non-transitory, computer-readable storage media of claim 18, wherein the at least some of the shards according to the second sharding scheme comprise:
a first shard comprising a first combination of keys selected for use in processing a first type of query workload; and
a second shard comprising another combination of keys selected for use in processing a second type of query workload, wherein:
the first and second combinations of keys include at least some same keys; and
the first and second combinations of keys include at least some different keys.
